(19) United States
(12) Patent Application Publication
(10) Pub. No.: US 2019/0136865 A1
(43) Pub. Date: May 9, 2019

(54) Aero/Hydro-dynamically Balanced Passively Varying Pitch Propeller

(71) Applicant: The Government of the United States of America, as represented by the Secretary of the Navy, Arlington, VA (US)

(72) Inventor: Stearns Beamon Heinzen, Alexandria, VA (US)

(21) Appl. No.: 16/185,410

(22) Filed: Nov. 9, 2018

Related U.S. Application Data
(60) Provisional application No. 62/583,661, filed on Nov. 9, 2017.

(51) Int. Cl. F04D 29/18

(52) U.S. Cl. CPC F04D 29/181; B64C 11/18

(57) ABSTRACT

A passively varying pitch propeller includes a hub and a first and a second blade assembly. Each blade assembly respectively has a blade having an airfoil shape yielding a positive zero-lift pitching moment for the blade assembly, a pitching axis located such that a disturbance in pitch angle creates a restoring pitching moment, yielding static pitch stability, and a mass distribution resulting in a zero pitching moment contribution due to product of inertia in a plane normal to blade pitch rotation.

### RELATED APPLICATIONS

This application claims the benefit of U.S. Provisional Application No. 62/583,661 filed Nov. 9, 2017, which is hereby incorporated herein by reference.

### FIELD OF INVENTION

The present invention relates generally to varying-pitch propellers, and more particularly to a passively varying-pitch propeller.

### BACKGROUND

The practice of pitching propeller blades to widen the efficient operating envelope to encompass takeoff velocities up to high speed cruise velocities is known for conventional fixed winged aircraft. This operation is generally accomplished with an electrically or hydraulically driven system allowing the pilot, or an automated system, to command a specific blade pitch angle for the desired operating mode. However, while a conventional system is appropriate for a manned sized vehicle, the additional required system weight and complexity makes it an impractical solution on many small unmanned platforms.

Several passive techniques have been investigated in the past for manned aircraft to achieve wide envelope efficiency without the additional system complexity. These include the Aeromatic line of propellers for general aviation aircraft, which make use of aerodynamic and inertial loading effects to pitch the propeller blade, and propellers with tailored stiffness, yielding pitch variability through flexure due to aerodynamic and inertial loading. These approaches are dependent on balancing aero forces/moments with a non-aero force or moment (inertial, inertial with structural stiffness). These quantities can vary independently from one another, causing blade equilibrium pitch angles to vary independent of inflow angles, this can yield inconsistent aerodynamic performance.

More recently some propellers, developed more specifically with the unmanned market in mind, include an aerodynamically actuated passive variable pitch propeller (PVPP) by the present inventor. This concept used multipart mass balance in the hub for each blade as well as gearing linking the two blades. Further, a torque actuated PVPP by Aerovate Inc. balances blade pitching moment against motor reaction torque, resulting in a constant torque formulation. A constant torque formulation can be limiting as propeller blades will pitch to unfavorable blade pitch angles when motor power is reduced, yielding poor aerodynamic performance.

### SUMMARY OF INVENTION

Therefore, presented herein is a practical Passively Varying Pitch Propeller (PVPP) which passively transitions from conventional airborne high speed flight, to low speed flight, to hovering flight, and/or to undersea operation. The system maintains efficient operation by blade angles adjusting appropriately to changing in-flow conditions, and doing so independently of operating RPM and medium. Adjustment is passive and independent of other vehicle systems which allows the propeller to be added to existing vehicles with no need to modify or add to the existing flight systems.

The present invention is appropriate for cases of extreme wide-envelope operation in which a vehicle has distinct modes of operation with very different propeller operating conditions and requirements, two examples are:

1. Multicopters are widely used as a general purpose platform for hovering payloads, such as cameras and sample missions. Optimization of these vehicles for efficient hovering flight means they are generally limited to low speed operation. To overcome this limitation a vehicle might be designed to transition to conventional horizontal flight, and make use of a common propulsion system in both hovering and horizontal flight modes. The vehicle will require an extremely wide envelope efficient propulsion system.

2. Unmanned flying-swimming vehicles operate and propulse in different manners but cumulatively indicate a need to develop bi-modal vehicles. Rather than such a vehicle carrying two propulsion systems, a common system, able to operate in air in a conventional propeller sense, as well as in water, where density of 1000 times greater, would be preferred.

According to one aspect of the invention, a passively varying pitch propeller includes a hub; and first and second blade assemblies. Each blade assembly respectively has an airfoil shaped to yield a positive zero-lift pitching moment for the blade assembly, a pitching axis located such that a disturbance in pitch angle creates a restoring pitching moment, yielding static pitch stability, and a mass distribution resulting in a zero pitching moment contribution due to product of inertia in a plane normal to blade pitch rotation.

Optionally, the first and second blade assemblies are configured to passively transition between two or more of conventional fixed-wing flight, hovering flight, or undersea operation.

Optionally, the first and second blade assemblies are configured to adjust blade angle to provide a stable and positive coefficient of lift in changing in-flow conditions independently of operating RPM and medium.

Optionally, the first and second blade assemblies are configured to adjust blade angle independent of all vehicle systems other than the passively varying pitch propeller.

Optionally, the pitching axis is placed forward of the aerodynamic center of the blade.

Optionally, the blade assembly includes a 3-lobed mass balance configured to balance the blade assembly on the blade pitch axis and to negate the product of inertia in the plane of blade pitch throughout entire range of blade pitch.

Optionally, the blade assembly includes a buoyancy distribution centered on the axis of rotation

Optionally, the blade assembly includes a buoyancy distribution matched blade to blade resulting in zero net buoyancy torque.

Optionally, the blade assemblies are rotatable along their respective pitching axes independent of each other.

Optionally, the first and second blade assemblies are a first pair of blade assemblies, and the propeller includes a second pair of blade assemblies, and wherein the first and second pairs of blade assemblies are axially offset from each other along a rotational axis of the propeller.

The foregoing and other features of the invention are hereinafter described in greater detail with reference to the accompanying drawings.

### BRIEF DESCRIPTION OF THE DRAWINGS

FIG. 1 shows a schematic of a varying-pitch propeller;

FIG. 2 shows a schematic of a varying pitch propeller;

FIG. 3 shows an exemplary blade assembly having a three-lobed mass balance;

FIG. 4 shows an exemplary three-lobed mass balance; and

FIG. 5 shows a portion of an exemplary propeller having two independently-rotatable blade assemblies with three-lobed mass balances.

### DETAILED DESCRIPTION

Exemplary PVPP propellers operate through a principle of balanced aerodynamic (or hydrodynamic) pitching moments. The behavior of these moments is tailored through the design process to result in stable thrust-producing blade pitch angles across the desired operating envelope.

During operation the moment contributions from Hydro/Aerodynamic pressure distribution should sum to zero to achieve a stable orientation. Whenever the propeller blades, which may be linked or, more preferably, free to rotate independently, encounter changing inflow conditions, the blades rotate to their new equilibrium angle, and maintain thrust and power coefficients at near optimum values for the propeller.

Exemplary propellers allow a common propulsion system to operate efficiently in completely different modes of operation. This includes across modes of airborne flight, such as hovering flight to high-speed conventional flight, or across operation in different mediums, such as airborne to undersea operation.

Two components of aerodynamic pitching moment are balanced for an Aero-based equilibrium in exemplary propeller: the airfoil pitching moment about its aero center, and the pitching moment due to lift coupled with the offset to the pivot point. Calculation of the pitching moment is complicated by flow field angles (relative to the propeller blade), and the changing relative airspeed due to propeller rotation.

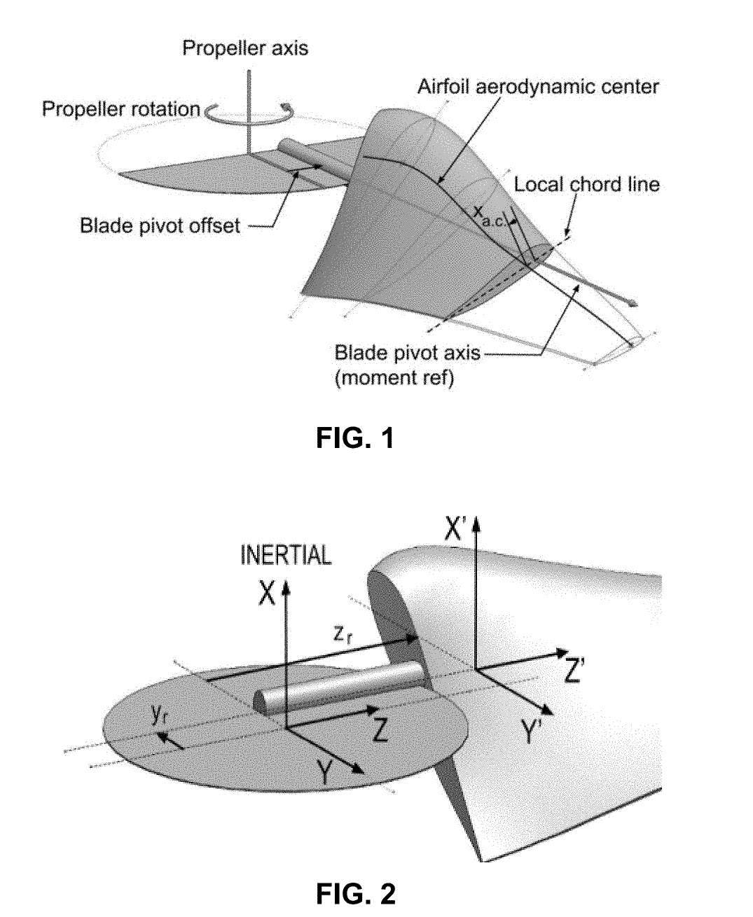

Referring to FIGS. 1 and 2, the problem of removing inertial effects can be reasonably simplified to two terms. The first caused by an off-pitch-axis blade CG:

CG offset effect=mω_{X′}²(ΔX′)(yᵣ+ΔY′), (1)

and the second by an imbalance in the products of inertia in the plane normal to blade pitching:

products of inertia effect=I_{X′Y′}(ω_{X′}²). (2)

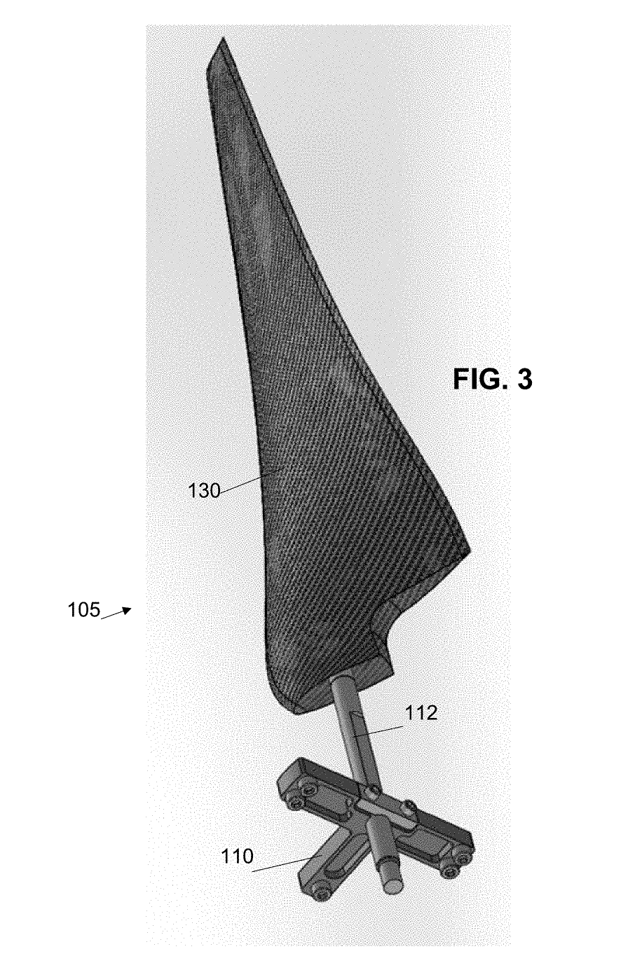

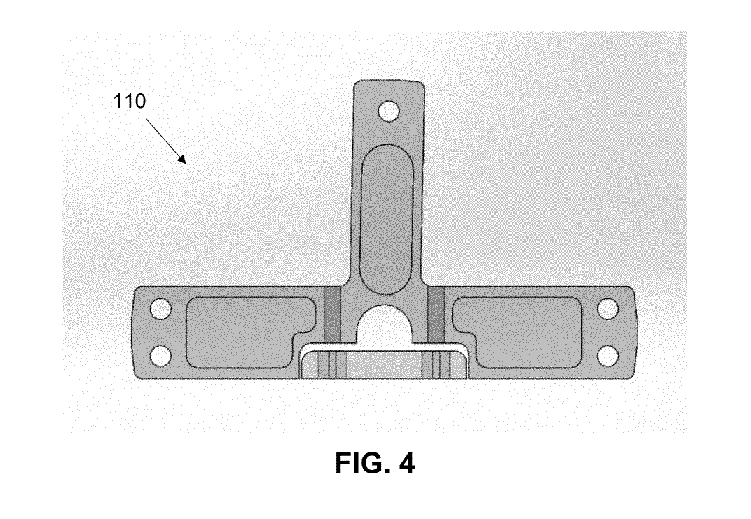

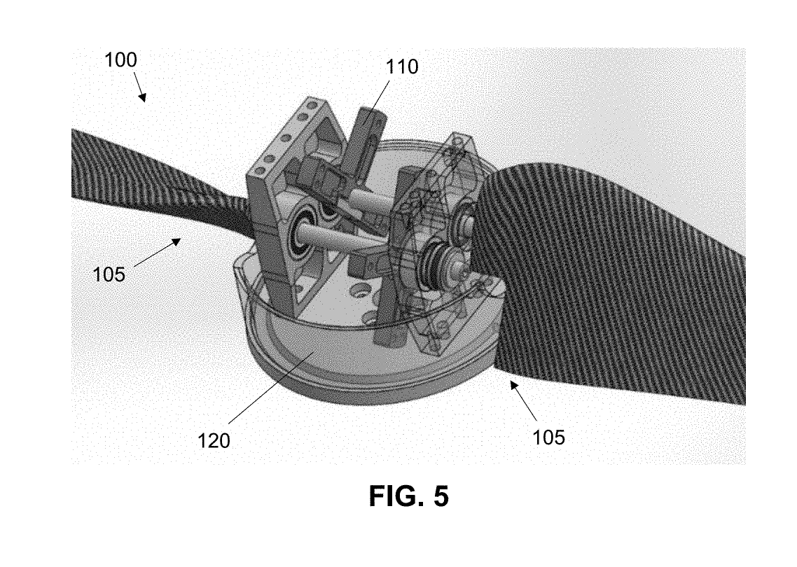

Referring now to FIGS. 3-5, a tailored monolithic three-lobed mass-balance 110 installed on the blade shaft/pitching axis 112 of a blade assembly 105 effectively cancels the inertial pitching contributions over the range of practical propeller angles. Reducing mass balancing to a single component reduces blade retention forces and in-hub complexity. Therefore, in exemplary propellers 100, a single three-lobed mass on each blade shaft provides both center of gravity balance, and products of inertia balancing. The single three-lobed mass configuration reduces the total required mass in the hub 120, facilitates compact integration of the mass balance with the hub, reduces bearing loads, and improves mass balance position fixing.

The blade shafts 112 in an exemplary two-blade propeller may be parallel and unconnected, allowing the propeller blades to pivot independently from one another such that the net pitching moment on each blade as the propeller rotates through 360 degrees is slightly variable, reducing hysteresis (dead-band) due to friction in the blade pitch bearings. This improves the consistent operation of the propeller. Unconnected shafts improve performance by reducing the effects of stiction in blade pitch during operation. Unconnected blades make the system more damage tolerant by isolating the blade mechanisms such that damage to one blade does not affect the undamaged blade's pitch trim and thrust, yielding redundancy in operation.

Although a two-blade propeller is illustrated for the sake of convenience, it will be understood that more than two blades may be used. In some exemplary embodiments, for example, 3, 4, or 5 blades may be used, but preferably an even number of blades with each opposite pair staggered along the axis of rotation of the propeller. In a 4-bladed propeller, for example, a blade assembly may be axially aligned along the axis of propeller rotation with the blade assembly 180 degrees around the propeller axis (i.e., the blades across from each other are axially aligned along the propeller axis). Meanwhile, the other blade pair (the pair 90 degrees offset from the first pair) may be axially aligned with each other along the rotational axis of the propeller. However, each pair of blade assemblies may be axially offset from each other pair along the rotational axis of the propeller.

To extend use of exemplary systems under water, further features may be added. For example, to achieve a pitch trim in the same passive manner when submerged, the pitch contribution of the blade net center of buoyancy must be removed. A tailored buoyancy balance may be used to move the net center of buoyancy (CB) of the propeller blade assembly to center on the blade pivot axis. The buoyancy balance can be incorporated into the three lobed mass balance or added as an additional component on the shaft and may include, e.g., empty or air-filled cavities/bladders and/or low-density (lower than water) material such as foam when adding a component to increase buoyancy in a particular location. Alternatively, the weight distribution in the lobed mass balance may also be designed to simultaneously contribute appropriate high-density (higher than water) material to locate the CB where desired.

When prop rotation is arrested, exemplary propeller blades have sufficient range of motion to weathervane (feather) into the flow. This yields a drag advantage during gliding flight and sea-gliding, and lessens the chance of propeller damage during water entry maneuvers.

In summary, the aero/hydro pitching moment of a propeller blade is dependent on several factors/behaviors:
1. The airfoil (cross sectional shape of the blade) is shaped to yield a positive zero lift pitching moment for the overall blade. This is similar to the requirement for a flying-wing tailless aircraft design and is accomplished by using a reflexed airfoil.
2. The pitching axis of the blade is placed such that a disturbance in pitch angle creates a restoring pitching moment, yielding static pitch stability. This is achieved by placing the axis forward of the aerodynamic center (or neutral point) of the propeller blade, and is analogous to proper placement of the center of gravity of an aircraft for stable flight. On the free-to-pitch propeller the neutral point is calculated taking into account the varying local flow velocities across the propeller blade.
3. Mass properties may be negated in two senses. First, the mass should shift the blade center of gravity to the center of blade pitch rotation. Secondly, the mass balance should be designed to zero the pitching moment contribution of the product of inertia in the plane normal to blade pitch rotation. (Achieved, for example, by a 3-lobed mass balance configured to balance the blade assembly on the blade pitch axis and to negate the product of inertia in the plane of blade pitch throughout the range of blade pitch.)
4. To negate buoyancy related pitching moments the center of buoyancy of each blade should be centered on the axis of rotation in the case of independent blades, or matched blade to blade in the case of rotation linked blades.
5. As inflow flow angles change, the propeller will weathervane into the flow to maintain a relatively constant positive average coefficient of lift (C_{L}) along the blade. This positive C_{L} translates to positive thrust.

Exemplary systems result in high efficiency flight across a range of conditions—from static conditions (hovering) to high speed conventional flight (200 kt). Exemplary systems can operate efficiently in air and water and can achieve variable pitch propeller performance at a fraction of the weight and complexity of conventional active controlled systems. Exemplary systems are bolt-on: they can be swapped for conventional fixed pitch propeller on existing systems without additional vehicle changes. Finally, exemplary systems allow a common propulsion system for multi-mode vehicles such as VTOL (multi-copters that transition to conventional flight), and flying swimmers.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A passively varying pitch propeller comprising:
a hub; and
a first and a second blade assembly, each blade assembly respectively having:
a blade having an airfoil shape yielding a positive zero-lift pitching moment for the blade assembly,
a pitching axis located such that a disturbance in pitch angle creates a restoring pitching moment, yielding static pitch stability, and
a mass distribution resulting in a zero pitching moment contribution due to product of inertia in a plane normal to blade pitch rotation.

2. The passively varying pitch propeller of claim 1, wherein the first and second blade assemblies are configured to passively transition between two or more of conventional fixed-wing flight, hovering flight, or undersea operation.

3. The passively varying pitch propeller of claim 1, wherein the first and second blade assemblies are configured to adjust blade angle to provide a stable and positive coefficient of lift in changing in-flow conditions independently of operating RPM and medium.

4. The passively varying pitch propeller of claim 1, wherein the first and second blade assemblies are configured to adjust blade angle independent of all vehicle systems other than the passively varying pitch propeller.

5. The passively varying pitch propeller of claim 1, wherein the pitching axis is placed forward of the aerodynamic center of the blade.

6. The passively varying pitch propeller of claim 1, wherein the blade assembly includes a 3-lobed mass balance configured to balance the blade assembly on the blade pitch axis and to negate the product of inertia in the plane of blade pitch throughout entire range of blade pitch.

7. The passively varying pitch propeller of claim 1, wherein the blade assembly includes a buoyancy distribution centered on the axis of rotation

8. The passively varying pitch propeller of claim 1, wherein the blade assembly includes a buoyancy distribution matched blade to blade resulting in zero net buoyancy torque.

9. The passively varying pitch propeller of claim 1, wherein the blade assemblies are rotatable along their respective pitching axes independent of each other.

10. The passively varying pitch propeller of claim 1, wherein the first and second blade assemblies are a first pair of blade assemblies, and the propeller includes a second pair of blade assemblies, and wherein the first and second pairs of blade assemblies are axially offset from each other along a rotational axis of the propeller.
